(19) United States
(12) Patent Application Publication
(10) Pub. No.: US 2014/0143158 A1
(43) Pub. Date: May 22, 2014

(54) Methods, Software And Devices For Automatically Calculating Valuations Of Leasable Commercial Property

(71) Applicant: HOLDCO 85 LP, Toronto (CA)

(72) Inventor: Michael Wilson, Uxbridge (CA)

(73) Assignee: HOLDCO 85 LP, Toronto (CA)

(21) Appl. No.: 14/083,535

(22) Filed: Nov. 19, 2013

(30) Foreign Application Priority Data
Nov. 20, 2012 (CA) 2,796,678

(51) Int. Cl. G06Q 30/02

(52) U.S. Cl. CPC G06Q 30/0278
USPC 705/306

(57) ABSTRACT

Methods, software and devices for valuing leasable assets are disclosed. A data model of future cash flows in defined time periods for those leasable assets is created. The data model is automatically populated with rent predicted by analyzing stored records of executed leasing agreements, each specifying rent for one of the leasable assets. The data model is also automatically populated with rent predicted by analyzing stored records of planned leasing agreements, each specifying rent for one of the leasable assets in time periods when rent is not specified by one of the executed leasing agreements. The data model is also automatically populated with rent predicted for the leasable assets by analyzing at least pre-defined market conditions, in time periods when rent is not specified by one of the executed leasing agreements or planned leasing agreements. A value of the leasable assets is calculated in dependence on the populated data model.

### CROSS REFERENCE TO RELATED APPLICATIONS

This U.S. patent application claims priority under 35 U.S.C. §119 from Canadian Patent Application No. 2,796,678, filed on Nov. 20, 2012, entitled “Methods, Software And Devices For Automatically Calculating Valuations Of Leasable Commercial Property,” which is hereby incorporated by reference in its entirety.

### TECHNICAL FIELD

The present disclosure relates to automated asset valuation, and more particularly to methods, software and devices for automatically calculating valuations of leasable commercial property.

### BACKGROUND

A commercial property leasing company routinely needs to calculate valuations for properties in its portfolio to make financial planning decisions and to meet financial reporting obligations. This portfolio may include different types of properties, e.g., for retail, office, commercial, or industrial purposes. Calculating valuations for those properties typically requires future revenues and expenses of the company to be predicted, which presents many challenges.

In particular, a commercial property leasing company may own a large portfolio of properties, with each property (e.g., a shopping mall, an office building, or an industrial building) divided into a large number of leasable units. Revenues for properties in portfolio include rents and recoveries of expenses, which are typically governed by leasing agreements formed between the company (the lessor) and tenants (lessees) of the leasable units. For example, these leasing agreements may dictate rent payable under the lease to be based on a rate per square foot and/or a percentage of the tenant's sales. The terms of these leasing agreements typically vary from lease to lease. Likewise, expenses for properties in the portfolio may include expenses unique to particular properties or particular leasable units. Further, leases are time-limited and thus leasing agreements are subject to change as they are renewed or replaced.

Thus, calculating valuations for leasable commercial property has been labor intensive, and prone to human error. Accordingly, there is a need for improved methods, software and devices for automatically calculating valuations for leasable commercial property.

### SUMMARY

In accordance with an aspect of the present disclosure, a computer-implemented method of valuing a plurality of leasable assets includes creating a data model of future cash flows in defined time periods for the plurality of leasable assets and populating the data model with rent predicted by analyzing stored records of executed leasing agreements. Each executed leasing agreement specifying rent for one of the leasable assets. The method includes populating the data model with rent predicted by analyzing stored records of planned leasing agreements, where each planned leasing agreement specifying rent for one of the leasable assets in those of the defined time periods when rent is not specified by one of the executed leasing agreements. The method also includes populating the data model with rent predicted for the plurality of leasable assets, by analyzing at least pre-defined market conditions, in those of the defined time periods when rent is not specified by one of the executed leasing agreements or planned leasing agreements, and calculating a value the plurality of leasable assets in dependence on the populated data model.

In accordance with another aspect of the present disclosure, a computing device for valuing a plurality of leasable assets includes at least one processor, memory in communication with the at least one processor, and software code stored in the memory. The software code, when executed by the at least one processor, causes the computing device to create a data model of future cash flows in defined time periods for the plurality of leasable assets, populate the data model with rent predicted by analyzing stored records of executed leasing agreements, each executed leasing agreement specifying rent for one of the leasable assets, and populate the data model with rent predicted by analyzing stored records of planned leasing agreements, each planned leasing agreement specifying rent for one of the leasable assets in those of the defined time periods when rent is not specified by one of the executed leasing agreements. The software code, when executed by the at least one processor, also causes the computing device to populate the data model with rent predicted for the plurality of leasable assets, by analyzing at least pre-defined market conditions, in those of the defined time periods when rent is not specified by one of the executed leasing agreements or planned leasing agreements, and calculate a value the plurality of leasable assets in dependence on the populated data model.

In accordance with yet another aspect of the present disclosure, a computer-readable medium stores instructions. The instructions when executed adapt a computing device to create a data model of future cash flows in defined time periods for the plurality of leasable assets and populate the data model with rent predicted by analyzing stored records of executed leasing agreements, each executed leasing agreement specifying rent for one of the leasable assets, and populate the data model with rent predicted by analyzing stored records of planned leasing agreements, each planned leasing agreement specifying rent for one of the leasable assets in those of the defined time periods when rent is not specified by one of the executed leasing agreements. The instructions when executed adapt the computing device to populate the data model with rent predicted for the plurality of leasable assets, by analyzing at least pre-defined market conditions, in those of the defined time periods when rent is not specified by one of the executed leasing agreements or planned leasing agreements, and calculate a value the plurality of leasable assets in dependence on the populated data model.

In accordance with still yet another aspect of the present disclosure, a computer-implemented method of valuing a plurality of leasable assets includes creating a data model of future cash flows in defined time periods for the plurality of leasable assets, populating the data model with rent predicted by analyzing stored records of leasing agreements, each leasing agreement specifying rent for one of the leasable assets, populating the data model with rent predicted for the plurality of leasable assets, by analyzing at least pre-defined market conditions, in those of the defined time periods when rent is not specified by one of the leasing agreements, and calculating a value the plurality of leasable assets in dependence on the populated data model.

In accordance with a further aspect of the present disclosure, a computing device for valuing a plurality of leasable assets includes at least one processor, memory in communication with the at least one processor, and software code stored in the memory. The software code, when executed by the at least one processor, causes the computing device to create a data model of future cash flows in defined time periods for the plurality of leasable assets, and populate the data model with rent predicted by analyzing stored records of leasing agreements, each leasing agreement specifying rent for one of the leasable assets. The software code, when executed by the at least one processor, also causes the computing device to populate the data model with rent predicted for the plurality of leasable assets, by analyzing at least pre-defined market conditions, in those of the defined time periods when rent is not specified by one of the leasing agreements, and calculate a value the plurality of leasable assets in dependence on the populated data model.

In accordance with a yet further aspect of the present disclosure, a computer-readable medium stores instructions that when executed adapt a computing device to create a data model of future cash flows in defined time periods for the plurality of leasable assets, and populate the data model with rent predicted by analyzing stored records of leasing agreements, each leasing agreement specifying rent for one of the leasable assets. The instructions when executed also adapt a computing device to populate the data model with rent predicted for the plurality of leasable assets, by analyzing at least pre-defined market conditions, in those of the defined time periods when rent is not specified by one of the leasing agreements, and calculate a value the plurality of leasable assets in dependence on the populated data model.

In accordance with another further aspect of the present disclosure, a computer-implemented method of predicting rents for a leasable unit of property in a pre-defined prediction period includes storing parameters of a leasing agreement for the leasable unit of property, the parameters specifying rent receivable by a lessor of the leasable unit of property during a portion of the pre-defined prediction period preceding termination of the leasing agreement, and receiving indicators of a plurality of market conditions predicted for the pre-defined prediction period. The method also generating parameters of at least one predicted leasing agreement, the generated parameters specifying rent predicted to be payable to the lessor during a portion the pre-defined prediction period following termination of the leasing agreement, the generating taking into account the plurality of market conditions, and predicting rents receivable by the lessor in the pre-defined prediction period by assessing the stored parameters and the generated parameters.

In accordance with still yet further aspect of the present disclosure, a computing device for valuing a plurality of leasable assets includes at least one processor, memory in communication with the at least one processor, and software code stored in the memory. The software code when executed by the at least one processor causes the computing device to store parameters of a leasing agreement for the leasable unit of property, the parameters specifying rent receivable by a lessor of the leasable unit of property during a portion of the pre-defined prediction period preceding termination of the leasing agreement, and receive indicators of a plurality of market conditions predicted for the pre-defined prediction period. The software code when executed by the at least one processor causes the computing device also to generate parameters of at least one predicted leasing agreement, the generated parameters specifying rent predicted to be payable to the lessor during a portion the pre-defined prediction period following termination of the leasing agreement, the generating taking into account the plurality of market conditions, and predict rents receivable by the lessor in the pre-defined prediction period by assessing the stored parameters and the generated parameters.

In accordance with an even further aspect of the present disclosure, a computer-readable medium stores instructions that when executed adapt a computing device to store parameters of a leasing agreement for the leasable unit of property, the parameters specifying rent receivable by a lessor of the leasable unit of property during a portion of the pre-defined prediction period preceding termination of the leasing agreement, and receive indicators of a plurality of market conditions predicted for the pre-defined prediction period. The instructions when executed adapt the computing device to generate parameters of at least one predicted leasing agreement, the generated parameters specifying rent predicted to be payable to the lessor during a portion the pre-defined prediction period following termination of the leasing agreement, the generating taking into account the plurality of market conditions, and predict rents receivable by the lessor in the pre-defined prediction period by assessing the stored parameters and the generated parameters.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is an exemplary network diagram illustrating a computer network, a server and end-user devices interconnected to the network.

FIG. 2 is a high level block diagram of a computing device for use as the server of FIG. 1.

FIG. 3 illustrates the software organization of the server of FIG. 1.

FIG. 4 is a high level block diagram of the modules of the valuation software of FIG. 3 executing at the server of FIG. 1.

FIG. 5 illustrates an exemplary web page presented by the valuation software of FIG. 3 for receiving user entry of terms of leasing agreements.

FIG. 6 illustrates an exemplary web page presented by the valuation software of FIG. 3 for receiving user entry of expenses.

FIG. 7 illustrates exemplary leasing scenarios in a short term forecast period.

FIG. 8 illustrates an exemplary web page presented by the valuation software of FIG. 3 for receiving predicted inflation rates.

FIG. 9 illustrates an exemplary web page presented by the valuation software of FIG. 3 for receiving predicted market conditions for renewals for an example property.

FIG. 10 illustrates an exemplary web page presented by the valuation software of FIG. 3 for receiving predicted market conditions for new leasing agreements for an example property.

FIG. 11 is a flowchart depicting exemplary blocks performed by the valuation software of FIG. 3.

FIG. 12 is a flowchart depicting exemplary blocks performed by the long term forecast module of FIG. 4.

FIG. 13A illustrates manually-entered leasing agreements received by the deal entry module of FIG. 4.

FIG. 13B illustrates renewal leasing agreements automatically generated by the long term forecast module of FIG. 4.

FIG. 13C illustrates new leasing agreements automatically generated by the long term forecast module of FIG. 4.

FIG. 14 illustrates an exemplary web page presented by the valuation software of FIG. 3 for receiving predicted discount/capitalization rates.

FIG. 15 illustrates an exemplary web page presented by the valuation software of FIG. 3 showing valuation results.

Like reference symbols in the various drawings indicate like elements.

### DETAILED DESCRIPTION

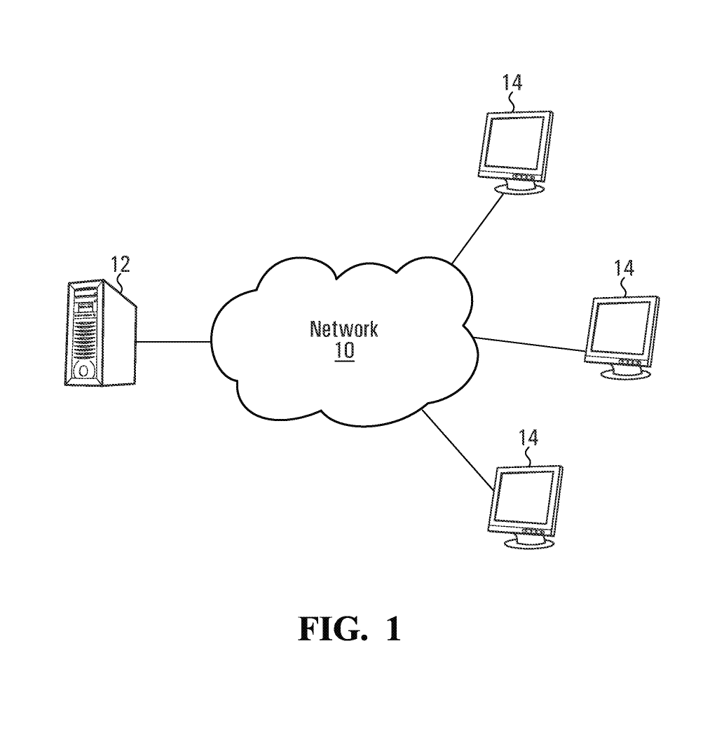

FIG. 1 illustrates an exemplary computer network and network interconnected server 12. As will become apparent, server 12 is a computing device that includes software for calculating valuations for commercial property, in manners exemplary of embodiments of the present disclosure.

As illustrated, server 12 is in communication with other computing devices such as end-user computing devices 14 through computer network 10. Network 10 may be a private intranet, but could also be the public Internet. So, network 10 could, for example, be an IPv4, IPv6, X.25, IPX compliant or similar network. Network 10 may include wired and wireless points of access, including wireless access points, and bridges to other communications networks, such as GSM/GPRS/3G/LTE or similar wireless networks. When network 10 is a public network such as the public Internet, it may be secured as a virtual private network.

Example end-user computing devices 14 are illustrated. End-user computing devices 14 are conventional network-interconnected computing devices used to access data and services through a suitable HTML browser or similar interface from network interconnected servers, such as server 12. As will become apparent, computing devices 14 are operated by users to interact with software executing at server 12. For example, computing devices 14 may be operated by users to enter data used to calculate valuations. When server 12 is interconnected with multiple computing devices 14, users may enter data in a collaborative manner. For example, terms of each leasing agreement may be entered by the particular employees responsible for negotiating and managing those leasing agreements. Computing devices 14 may also be operated by those or other employees to receive valuation results.

The architecture of computing devices 14 is not specifically illustrated. Each computing device 14 may include a processor, network interface, display, and memory, and may be a desktop personal computer, a laptop computing device, a network computing device, a tablet computing device, a personal digital assistant, a mobile phone, or the like. Computing devices 14 may access server 12 by way of network 10. As such, computing devices 14 typically store and execute network-aware operating systems including protocol stacks, such as a TCP/IP stack, and web browsers such as Microsoft Internet Explorer, Mozilla Firefox, Google Chrome, Apple Safari, or the like.

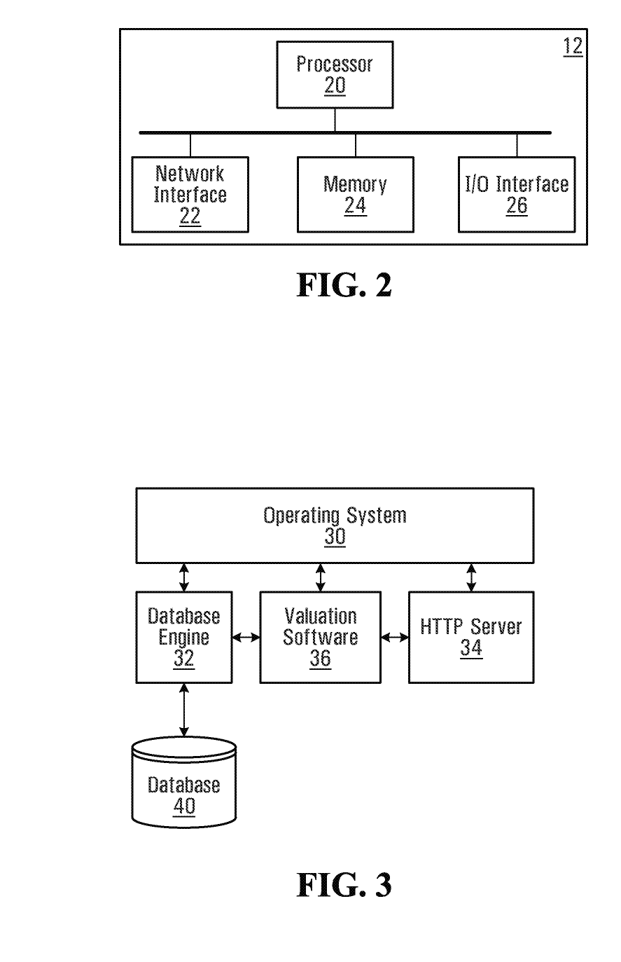

FIG. 2 is a high-level block diagram of a computing device that may act as server 12. As illustrated, server 12 includes one or more processors 20, network interface 22, a suitable combination of persistent storage memory 24, random access memory and read only memory, one or more I/O interfaces 26. Processor 20 may be an Intel x86, PowerPC, ARM processor or the like. Network interface 22 interconnects server 12 to network 10. Memory 24 may be organized using a conventional filesystem, controlled and administered by an operating system governing overall operation of server 12. Server 12 may store in memory 24, through this filesystem, software for calculating valuations, files for providing users an interface to this software, input data for calculating valuations, and valuation results, as detailed below. Server 12 may include input and output peripherals interconnected to server 12 by one or more I/O interfaces 26. These peripherals may include a keyboard, display and mouse. These peripherals may also include devices usable to load software components exemplary of embodiments of the present disclosure into memory 24 from a computer readable medium. Server 12 executes these software components to adapt it to operate in manners exemplary of embodiments of the present disclosure, as detailed below.

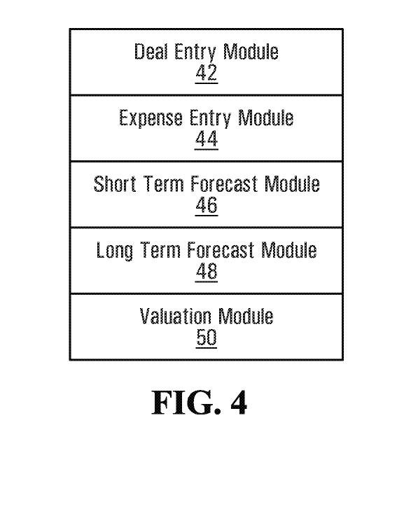

FIG. 3 illustrates a simplified organization of example software components stored within persistent storage memory 24 of server 12, as depicted in FIG. 2. As illustrated, software components includes operating system (OS) software 30, database engine 32, database 40, a hypertext transfer protocol (“HTTP”) server application 34, and valuation software 36, exemplary of embodiments of the present disclosure. Database 40 may be stored in memory 24 of server 12. Also illustrated are data files 38 used by valuation software 36 and HTTP server application 34.

OS software 30 may, for example, be a Unix-based operating system (e.g., Linux, FreeBSD, Solaris, OSX, etc.), a Microsoft Windows operating system or the like. OS software 30 allows valuation software 36 to access processor 20, network interface 22, memory 24, and one or more I/O interfaces 26 of server 12. OS software 30 may include a TCP/IP stack allowing server 12 to communicate with interconnected computing devices, such as computing devices 14, through network interface 22 using the TCP/IP protocol.

Database engine 32 may be a conventional relational or object-oriented database engine, such as Microsoft SQL Server, Oracle, DB2, Sybase, Pervasive or any other database engine known to those of ordinary skill in the art. Database engine 32 provides access to one or more databases 40, and thus typically includes an interface for interaction with OS software 30, and other software, such as valuation software 36. Database 40 may be a relational or object-oriented database. As will become apparent, database 40 stores data used to calculate valuations, such as terms of lease agreements, past expenses, predicted market conditions, etc., entered by users of computing devices 14. Valuation software 36 may access database 40 through database engine 32. In some embodiments, valuation software 36 may access stored data using an intermediary web application platform such as Microsoft SharePoint, executing at server 12.

HTTP server application 34 is a conventional HTTP web server application such as the Apache HTTP Server, nginx, Microsoft IIS, or similar server application. HTTP server application 34 allows server 12 to act as a conventional HTTP server and provides a plurality of web pages of a web site, stored for example as (X)HTML or similar code, for access by interconnected computing devices such as computing devices 14. Web pages may be implemented using traditional web languages such as HTML, XHTML, Java, Javascript, Ruby, Python, Perl, PHP, Flash or the like, and stored in files 38 at server 12. Web pages may also be implemented using a web application platform such as Microsoft Sharepoint, executing at server 12.

Valuation software 36 adapts server 12, in combination with database engine 32, database 40, OS software 30, and HTTP server application 34 to function in manners exemplary of embodiments of the present disclosure. Valuation software 36 may include user interfaces written in a language allowing their presentation on a web browser, or code that will dynamically generate such user interfaces. As will be apparent, users of computing devices 14 may interact with these user interfaces to enter data needed for calculating valuations, or to receive calculated valuations. User interfaces of valuation software 36 may be provided in the form of web pages by way of HTTP server application 34 to computing devices 14 over network 10.

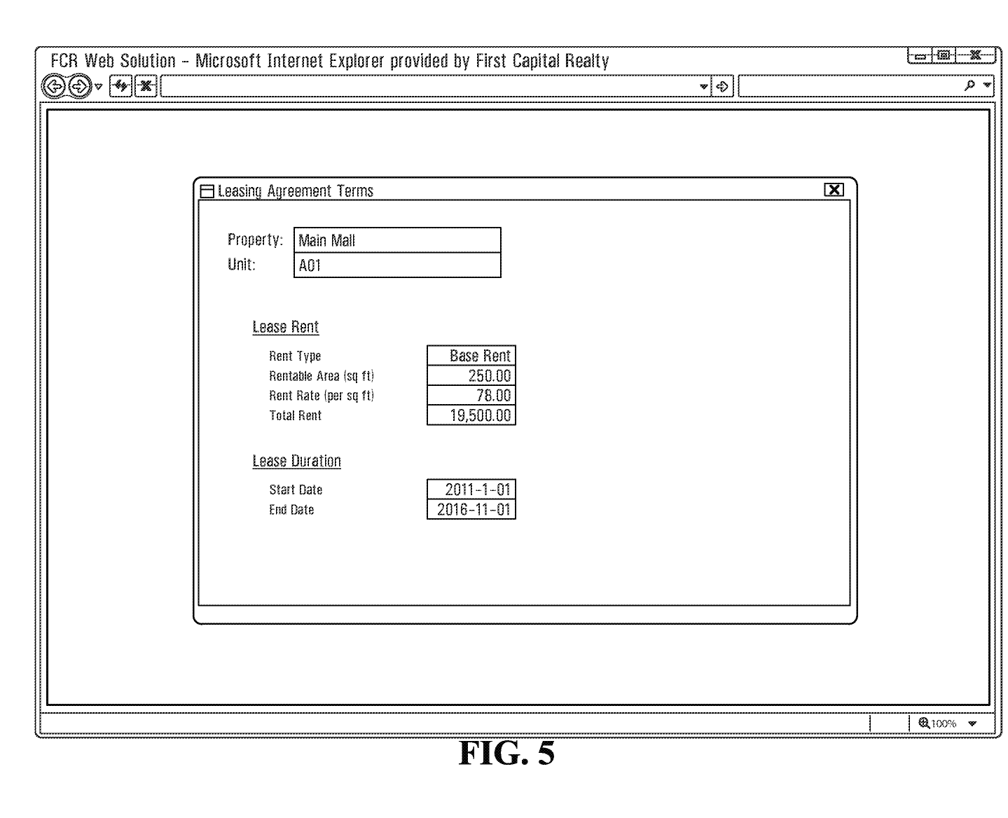

In the embodiment depicted in FIG. 4, valuation software 36 includes deal entry module 42, expense entry module 44, short term forecast module 46, long term forecast module 48, and valuation module 50. These modules may be written using conventional computing languages such as C, C++, C#, Perl, Javascript, Java, Visual Basic or the like. These modules may be in the form of executable applications, scripts, or statically or dynamically linkable libraries. The function of each of these modules is detailed below.

In the depicted embodiment, valuation software 36 calculates valuations based on the net present value of future cash flows for leasable properties. As such, valuation software 36 uses a data model of future cash flows, stored, e.g., in database 40. This data model includes data fields for containing revenues and expenses predicted for each of the leasable properties to be valued for a series of defined time periods forming a prediction period, e.g., where each defined time period is a month or a year. The time periods may be defined to be the same for all of the leasable properties, or may be uniquely defined for some or all of the leasable properties. As such, the length of the prediction period may be the same for all of the leasable properties, or may vary from property to property. This data model is populated with revenues and expenses predicted by short term forecast module 46 and long term forecast module 48. Valuation module 50 then uses the populated data model of cash flows to calculate valuations for leasable properties.

Deal entry module 42 allows users of computing devices 14, such as employees of a commercial property leasing company, to enter or modify terms of leasing agreements. To facilitate entry and modification of these terms, deal entry module 42 presents a user interface in the form of one or more web pages by way of HTTP server 34 executing at server 12.

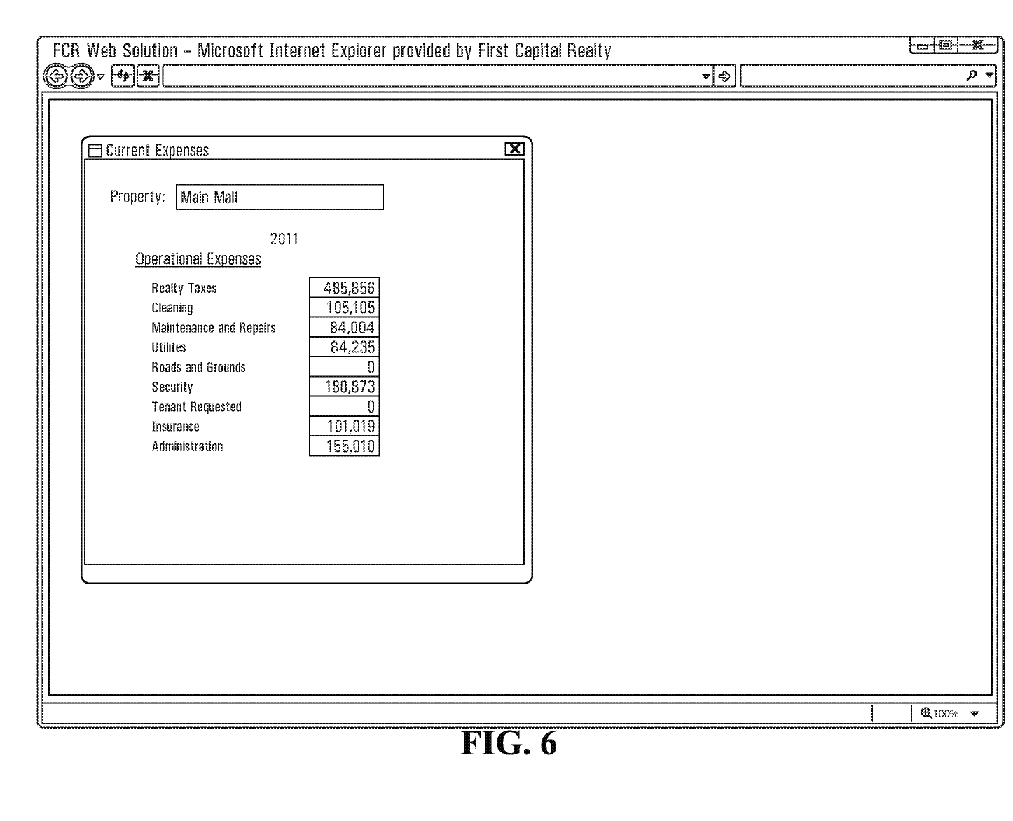

FIG. 5 depicts a sample screen of a user interface for specifying terms of a leasing agreement, as presented to users by deal entry module 42, exemplary of an embodiment. As shown, users are presented with a web page including an interface to enter leasing agreement terms. These terms include parameters governing rent payable, such as rent per square foot and rentable area, as well as parameters governing lease duration (e.g., start date and end date). Other interfaces may be presented to users for entering parameters for other forms of rent such as rent based on a percentage of the tenant's sales. Yet other interfaces may be presented to users for entering terms related to recovery from tenants of expenses incurred by the company, such as expenses related to common area management (CAM), electricity, garbage removal, insurance, property taxes, etc. Further interfaces may be presented to users for entering other lease terms, such as the terms of renewal clauses, if any. Further interfaces may also be presented to users for entering information identifying the particular leasable unit to which the leasing agreement applies.

Deal entry module 42 receives terms of existing leasing agreements, i.e., for which a binding contract with a tenant has been formed. In some embodiments, deal entry module 42 may also receive terms of leasing agreements that are still undergoing negotiation, or terms of leasing agreements for which no prospective tenant has been identified. Such leasing agreements for which no binding contract has yet been formed with a tenant may be collectively referred to as planned leasing agreements. There may be multiple planned leasing agreements for any particular leasable unit. Deal entry module 42 may receive updated terms for such planned leasing agreements as negotiations progress or plans change. As will be apparent, the terms of planned leasing agreements are used in conjunction with the terms of existing leasing agreements to predict future revenues.

Deal entry module 42 stores records of all received terms of leasing agreements in database 40 by way of database engine 32, along with indicators of whether those terms are for existing leasing agreements or planned leasing agreements.

In some embodiments, deal entry module 42 may interact with other systems used by the commercial property leasing company, such as a system for obtaining approval for planned leasing agreements from stakeholders of a commercial property leasing company, e.g., as described in Canadian Patent Application No. 2,769,793. Conveniently, in such embodiments, terms of leasing agreements entered by users may be used for disparate purposes, e.g., for obtaining approvals and for calculating valuations. When terms of leasing agreements are entered on a rolling basis, e.g., whenever approval is required before leasing agreements are formed, records of such terms may already be stored at server 12 when need arises to calculate valuations.

In some embodiments, deal entry module 42 may receive terms of leasing agreements not from users, but from a database stored at server 12 or interconnected to server 12 by way of network 10. In such embodiments, deal entry module 42 need not include any user interfaces.

Expense entry module 44 allows users of computing devices 14 to enter expenses of the commercial property leasing company. Expenses may be those incurred by the company in the past and/or expenses for the current time period. To facilitate entry of expenses, expense entry module 44 presents a user interface in the form of one or more web pages by way of HTTP server 34 executing at server 12.

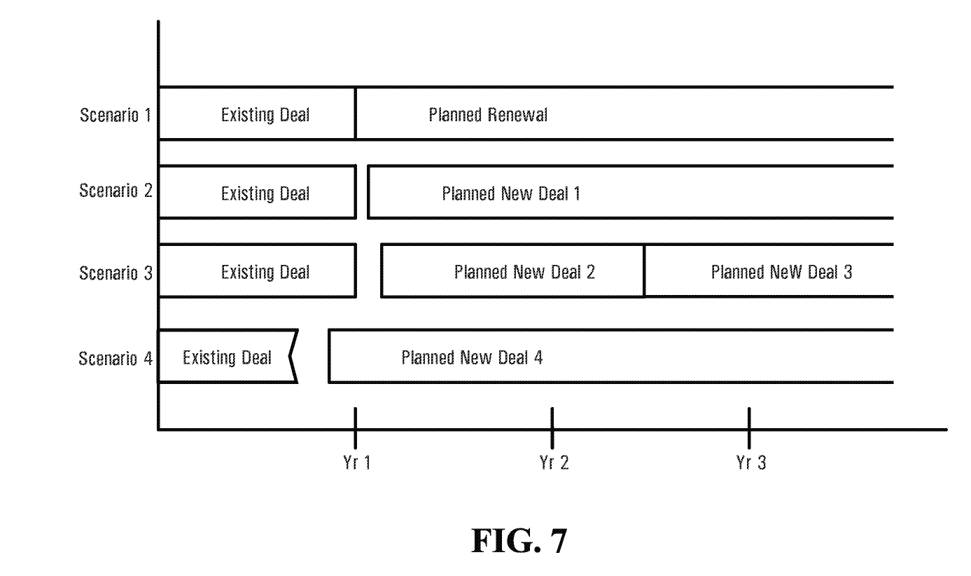

FIG. 6 depicts a sample screen of a user interface for specifying expenses, as presented to users by expense entry module 44, exemplary of an embodiment. As shown, users are presented with a web page including an interface to enter operational expenses for a particular property (Main Mall), such as expenses relating to realty taxes, cleaning, maintenance and repairs, utilities, etc. Other interfaces may be presented to users for entering non-operational expenses such as capital expenditures. Yet other interfaces may be presented to users for entering expenses related to a particular leasable unit. Further interfaces may be presented to users for entering expenses incurred by the company which are not attributable to any particular property or leasable unit.

Expense entry module 44 stores records of all received expenses in database 40 by way of database engine 32.

In some embodiments, expense entry module 44 may interact with other computerized systems used by the commercial property leasing company, such as a system for processing invoices for expenses. Thus, expenses entered by users may be used for disparate purposes. When expenses are entered on a rolling basis, e.g., whenever an invoice for an expense is processed, records of such expenses may already be stored at server 12 when need arises to calculate valuations.

In some embodiments, expense entry module 44 may receive expense data not from users, but from a database stored at server 12 or interconnected to server 12 by way of network 10. In such embodiments, deal entry module 42 need not include any user interfaces.

Short term forecast (STF) module 46 forecasts revenues and expenses for a short term forecast period, e.g., the next 3 years, and populates the cash flow data model using these forecasted revenues and expenses. As will be readily appreciated, the duration of the short term forecast period may vary depending on financial management requirements, which may vary from company to company, and from time to time.

STF module 46 may forecast revenues and expenses for the short term forecast period for a portfolio of properties, each including multiple leasable units, for a particular property within that portfolio, or for a particular leasable unit within a particular property. This scope of forecasting may be pre-defined or selected by the user during operation.

Revenues from leasable units are governed by the terms of the leasing agreements for each of those leasable units. Thus, to forecast revenues over the short term forecast period, STF module 46 retrieves records of terms of leasing agreements from database 40 by way of database engine 32. Depending on the scope of the forecasting required, STF module 46 may retrieve records of terms of leasing agreements for the company's entire portfolio of properties, for a particular property, or for a particular leasable unit. Retrieved terms may include terms of existing leasing agreements, as well as terms of planned leasing agreements.

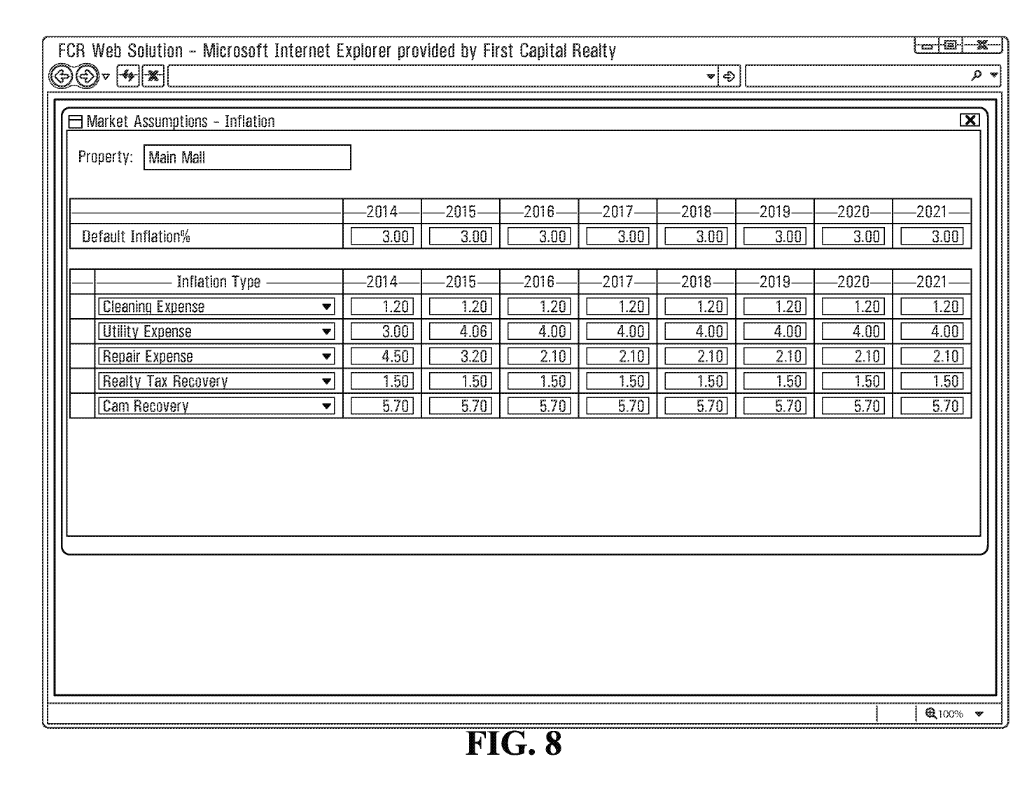

For any particular leasable unit, STF module 46 may retrieve terms of several different planned leasing agreements from database 40, e.g., when several prospective tenants have been identified for that unit. Two or more planned leasing agreements for the same leasable unit may overlap in time, creating alternative leasing scenarios in the forecast period. As illustrated in FIG. 7, for an example leasable unit, STF module 46 may retrieve terms for an existing leasing agreement (shown as “Existing Deal”), as well as terms for five example planned leasing agreements (shown as “Planned Renewal”, “Planned New Deal 1”, “Planned New Deal 2”, “Planned New Deal 3”, and “Planned New Deal 4”, respectively). As illustrated, the existing leasing agreements and the planned leasing agreements for this example leasable unit create four possible leasing scenarios in the forecast period.

In these scenarios, the existing leasing agreement (Existing Deal) for the exemplary leasable unit is due to expire during the short term forecasting period in one year's time (at Year 1). In Scenario 1, when the Existing Deal expires, the tenant is predicted to renew the leasing agreement (Planned Renewal), which will extend beyond the short term forecast period. In Scenario 2, when the Existing Deal expires, a new leasing agreement is predicted to be formed, possibly with a different tenant (Planned New Deal 1). In Scenario 3, the Existing Deal is predicted to be followed by two consecutive planned leasing agreements: Planned New Deal 2, to last from Year 1 to Year 2, and Planed New Deal 3, to extend from Year 2 onward. In Scenario 4, the Existing Deal is predicted to be terminated before its scheduled expiry, and to be followed by a planned leasing agreement that begins before Year 1 (Planned New Deal 4). As will be appreciated, these four scenarios are exemplary only, and many other scenarios are possible.

STF module 46 predicts revenues in the short term forecast period based on one of the leasing scenarios created by combinations of the existing leasing agreement and the planned leasing agreements. To this end, STF module 46 may present a user interface in the form of one or more web pages to users of computing devices 14 by way of HTTP server 34 executing at server 12. This user interface presents the various planned leasing agreements to the user and allows the user to select a subset of those planned leasing agreements for inclusion in the forecasting. In some embodiments, the user may be requested to select the planned leasing agreements that are most likely to be executed during the forecast period.

In other embodiments, STF module 46 may present other user interfaces requesting the user to select planned leasing agreements corresponding to best-case or worst-case scenarios, instead of or in place of the most likely planned leasing agreements. Such selections may be used to predict best-case or worst-case revenues for financial management purposes.

For each particular leasable unit within the scope of the forecasting, STF module 46 predicts revenues for that leasable unit during the short term forecast period by analyzing the terms of the existing leasing agreement and the planned leasing agreements selected for inclusion in the forecasting. STF module 46 analyzes these terms to determine revenues, e.g., in the form of periodic rents payable to the company, as well as periodic payments due to the company for recovery of the company's expenses related to common area management (CAM), electricity, garbage removal, insurance, property taxes, etc. Rents may be reduced by any tenant inducements (e.g., months of free month) or any commissions, according to the terms of the leasing agreements. In this way revenues are predicted for each time period (e.g., each month or each year) in the short term forecast period.

To predict expenses over the short term forecast period, STF module 46 retrieves records of past and/or current expenses from database 40 by way of database engine 32. STF module 46 may predicts expenses over the short term forecast period by projecting past or current expenses, as stored in these records. For example, current expenses may simply be replicated over the short term forecast period. Optionally, expenses in the short term forecast period may be adjusted for inflation. In such embodiments, adjustments for inflation may be based on a pre-defined inflation rate or user-selected inflation rate. In this way, expenses are predicted for each time period in the short term forecast period.

In some embodiments, STF module 46 may also predict other expenses by analyzing the terms of the existing leasing agreement and the planned leasing agreements selected for inclusion in the forecasting. STF module 46 analyzes these terms to determine if any terms obligate the lessor to incur specific expenses in the short term forecast period, e.g., for repairs or upgrades of the property, or for tenant inducements.

Different forms of predicted revenues and expenses are summed by STF module 46 to determine total annual revenues/expenses over the short term forecast period. Revenues/expenses from all the leasable units within a particular property may also be summed to determine total annual revenues/expenses over the short term forecast period for that property. Further, revenue/expenses from all properties within the company's portfolio may be summed to determine total annual revenues/expenses over the short term forecast period for the company.

Optionally. STF module 46 may present user interfaces containing predicted revenues/expenses in the form of one or more web pages to users of computing devices 14 by way of HTTP server 34 executing at server 12. These user interfaces may present revenues/expenses for the portfolio of properties, a particular property, or a particular leasable unit. In some embodiments, these user interfaces may allow users to modify predicted revenues/expenses. Such modifications are then received by STF module 46 and replace the automatically calculated revenues/expenses.

STF module 46 populates the cash flow data model with forecasted revenues and expenses, e.g., by storing records of those revenues and expenses in database 40 by way of database engine 32.

Long term forecast (LTF) module 48 forecasts revenues and expenses for a long term forecast period, covering a period after the short term forecast period, and populates the cash flow data model using these forecasted revenues and expenses. The long term forecast period may, for example, cover a period extending from 4 to 10 years into the future. As will be readily appreciated, the duration of the long term forecast period may vary depending on financial management requirements, which may vary from company to company, and from time to time.

LTF module 48 may forecast revenues and expenses for the long term forecast period for a portfolio of properties, a particular property, or a particular leasable unit. This scope of forecasting may be pre-defined or selected by the user during operation.

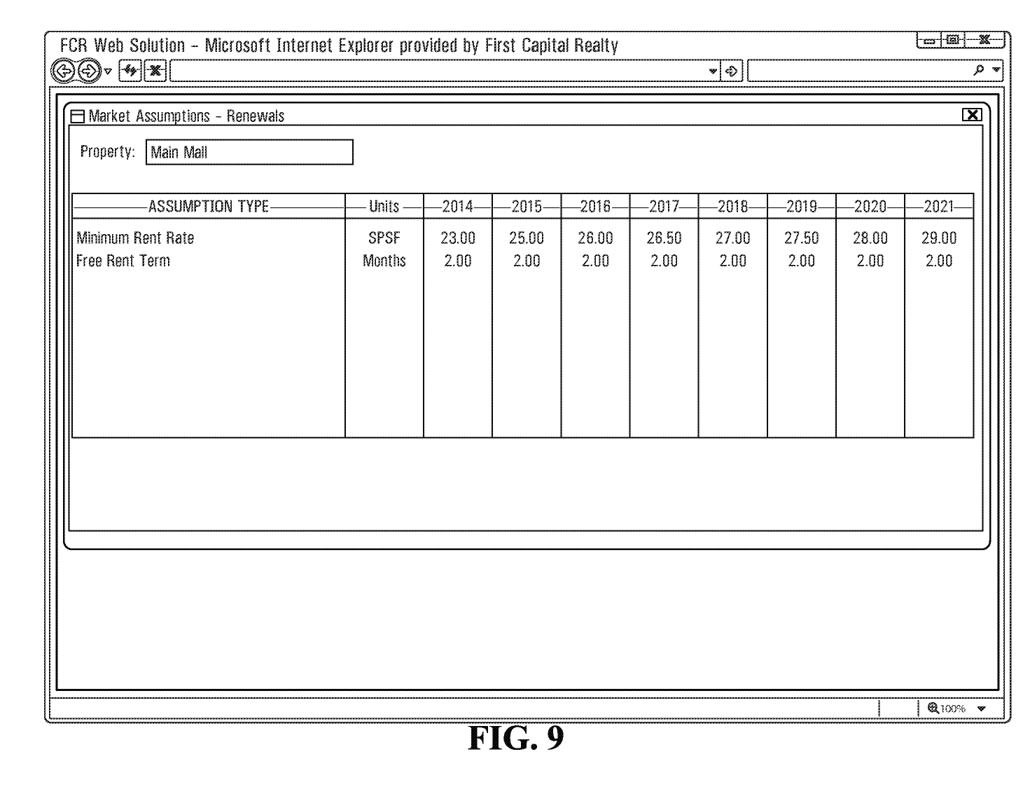

FIG. 8 depicts a sample screen of a user interface presented to users by LTF module 48 for specifying predicted inflation rates in the long term forecast period, exemplary of an embodiment. As illustrated, predicted inflations rates include rates for various types of expenses, specified for each year in the long term forecast period. The predicted inflation rates also include default inflation rates for each year, which apply to other types of expenses, for which inflation rates have not been otherwise specified. The predicted inflation rates may also include rates for various types of revenues.

LTF module 48 forecasts expenses over the long term forecast period, based on their values determined by STF module 46 for the short term forecast period. Accordingly, LTF module 48 retrieves the values of these expenses at the end of the short term forecast period from database 40 by way of database engine 32. These expenses may be replicated over the long term forecast period, adjusted for inflation based on the inflation rates received by LTF module 48. These expenses are predicted for each time period (e.g., each month or each year) in the long term forecast period.

In some embodiments, similarly to STF module 46, LTF module 48 may further predict other expenses over the long term forecast period by analyzing the terms of any existing leasing agreement and those planned leasing agreements selected for inclusion in the forecasting to identify any expenses dictated by those agreements.

LTF module 48 predicts revenues by automatically generating leasing agreements to supplement existing and planned leasing agreements, as detailed below. As noted, STF module 44 forecasts revenues using the terms for existing and planned leasing agreements. Typically, these terms are those manually entered by users of computing devices 14 and received by deal entry module 42. However, for at least some leasable units, manually entered leasing agreements will not span the entire long term forecast period. As such, LTF module 48 fills the long term forecast period by automatically generating leasing agreements for those leasable units.

LTF module 48 automatically generates two types of leasing agreements: predicted renewals where a manually entered leasing agreement contains a renewal clause, and predicted new leasing agreements.

LTF module 48 automatically generates predicted leasing agreements based on predicted market conditions. To this end, LTF module 48 may present a user interface in the form of one or more web pages to users of computing devices 14 by way of HTTP server 34 executing at server 12, to allow users to enter predicted market conditions.

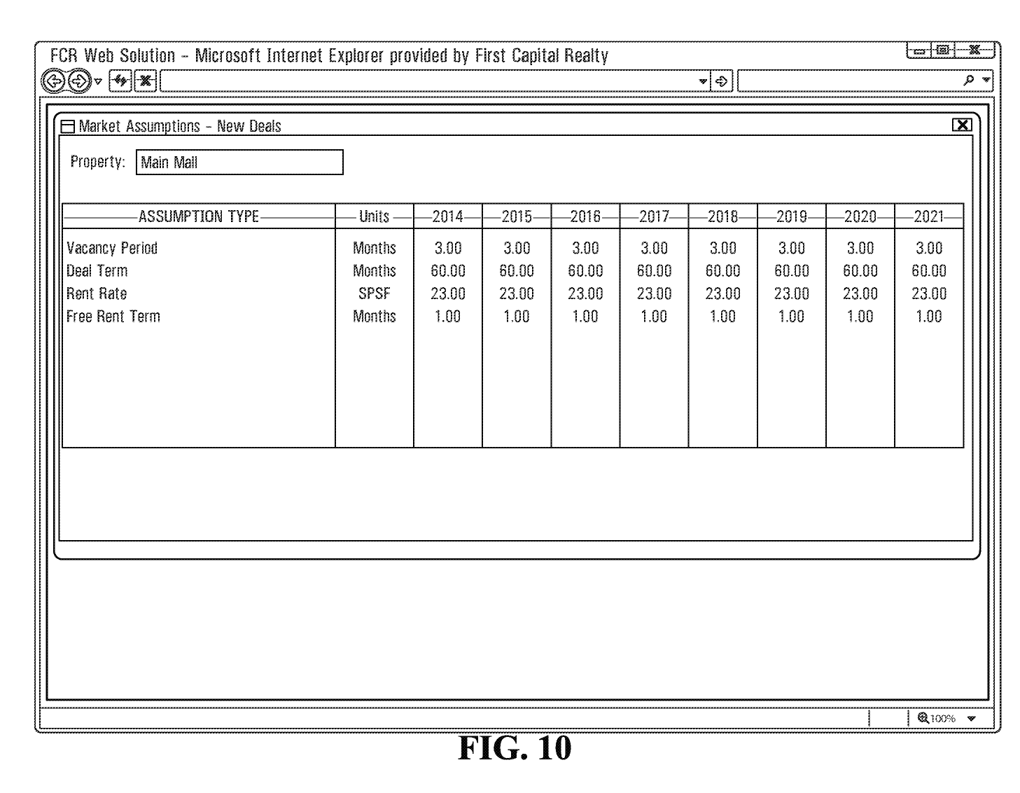

FIG. 9 depicts a sample screen of a user interface presented to users by LTF module 48 for specifying predicted market conditions for renewals in the long term forecast period, exemplary of an embodiment. As illustrated, these market conditions include, for example, the predicted rate of rent for renewals and the predicted number of months of free rent granted to tenants as an inducement for renewing, specified for each year in the long term forecast period. Other market conditions such as the predicted commission rate for renewals may be specified by users by way of other interfaces.

For each leasable unit within the scope of the forecasting, LTF module 48 analyzes the existing/planned leasing agreements retrieved from database 40 to determine if these leasing agreements extend through the entire duration of the long term forecast period. If LTF module 48 determines that these leasing agreements expire during the long term forecast period, thereby creating an expected vacancy, LTF module 48 further analyzes the last-expiring leasing agreement to determine if it contains a renewal clause. If a renewal clause is found, LTF module 48 automatically generates a predicted renewal of that last-expiring leasing agreement. Terms of the predicted renewal such as rent (e.g., rate per square foot) are set based on the predicted market conditions for predicted renewals, as described above. Other terms of the predicted renewal such as terms governing recoveries for expenses are set based on predicted expenses, and may take into account inflation rates governing recoveries predicted for the long term forecast period. Yet other terms of the predicted renewal such as the lease duration are based on the terms of the preceding leasing agreement, for which a renewal has been predicted.

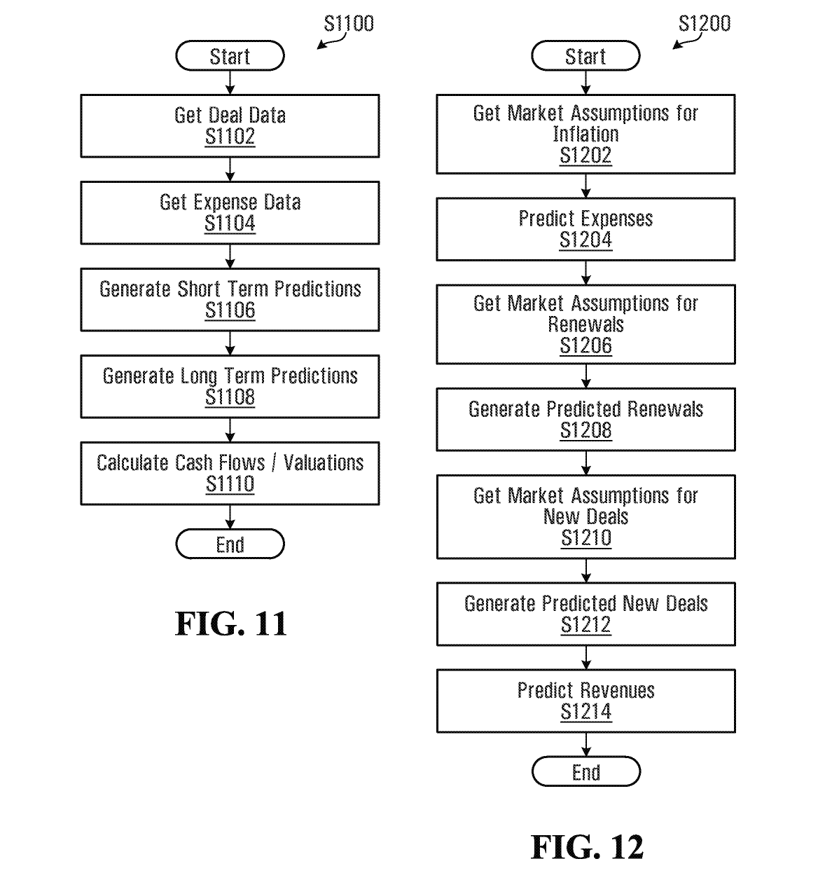

FIG. 10 depicts another sample screen of a user interface presented to users by LTF module 48 for specifying predicted market conditions for new leasing agreements in the long term forecast period, exemplary of an embodiment. As illustrated, these market conditions include those reflective of demand for the leasable units during the long term forecast period. For example, these market conditions may include the predicted rate of rent for new leasing agreements, the predicted vacancy period between expiry of prior leasing agreements and new leasing agreements, the length of new leasing agreements, etc., specified for each year in the long term forecast period. Other market conditions such as the predicted commission rate for new leasing agreements, any tenant inducements such as months of free month, etc., may be specified by users by way of other interfaces.

For each leasable unit within the scope of the forecasting, LTF module 48 analyzes the existing/planned leasing agreements retrieved from database 40 as well as the automatically generated predicted renewals to determine if these leasing agreements extend through the entire duration of the long term forecast period. If LTF module 48 determines that these leasing agreements expire during the long term forecast period, thereby creating a vacancy, LTF module 48 automatically generates predicted new leasing agreements to fill these vacancies in the long term forecast period. The terms of these predicted new leasing agreements, such as duration, rent, etc., are set based on the predicted market conditions.

FIGS. 8, 9 and 10 depict sample screens of user interfaces presented to users for entering predicted market conditions related to a particular property (Main Mall). Other interfaces may be presented to users for entering market conditions for the entire portfolio of properties, or a type of leasable unit within a particular property, or a particular leasable unit within a particular property. As will be appreciated, the market conditions shown in FIGS. 8, 9 and 10 are exemplary only, and other parameters will be readily apparent to persons of ordinary skill in the art.

For each particular leasable unit within the scope of the forecasting, LTF module 48 predicts revenues for that leasable unit during the long term forecasting period by analyzing the terms of the existing leasing agreement, planned leasing agreements selected for inclusion in the forecasting, and any automatically generated renewals or new leasing agreements.

For each particular leasable unit, different forms of revenues and expenses are summed by LTF module 48 to determine total annual revenues/expenses over the long term forecast period. Revenues/expenses from all the leasable units within a particular property may also be summed to determine annual revenues/expenses in the long term forecast period for that property. Further, revenue/expenses from all properties within the company's portfolio may be summed to determine annual revenues/expenses over the long term forecast period for the company.

LTF module 48 populates the cash flow data model with forecasted revenues and expenses, e.g., by storing records of those revenues and expenses in database 40 by way of database engine 32.

Valuation module 50 calculates valuations for leasable property using the cash flow data model, populated with revenues and expenses forecasted by STF module 46 and LTF module 48. Valuation module 50 may calculate valuations for the company, based on its entire portfolio of properties, or for particular properties or leasable units.

Valuation module 50 calculates valuations according to standard valuation techniques. For example, valuations may be calculated using the discounted cash flow valuation technique. According to this technique, a valuation of the company (or particular properties or leasable units) may be calculated as the net present value of a series of future cash flows, including any terminal value.

Future cash flows may be calculated according to standard accounting practices. For example, cash flow for a property in a given year may be calculated as the difference between cash flowing into a company from that property and cash flowing out of the company for that property, as determined from revenues and expenses forecasted for that property for that year. The present value of a future cash flow may be calculated, for example, as FVₙ=(1−d)ⁿ, where FVₙ is the nominal value of a future cash flow n years into the future and d is a specified discount rate.

Valuations may be also calculated using other well-known valuation techniques, e.g., by dividing the net operating income for a given year by a specified capitalization rate. Many other valuation techniques will be readily apparent to persons of ordinary skill in the art.

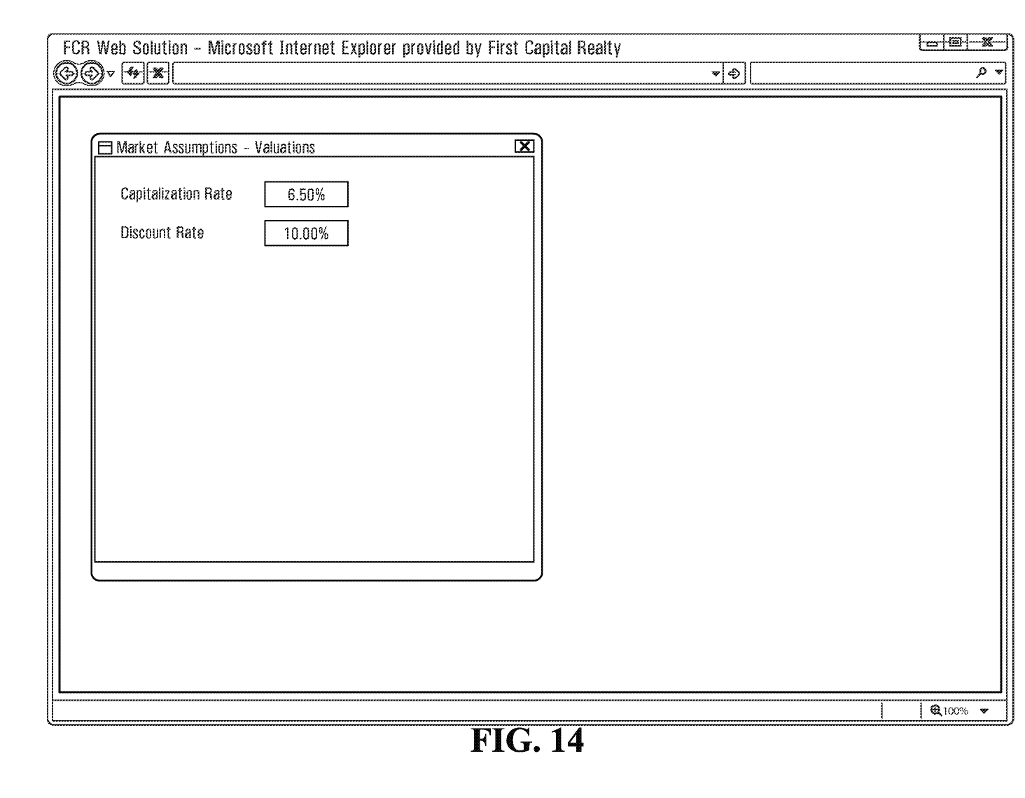

FIG. 14 depicts a sample screen of a user interface presented to users for specifying the discount rate or capitalization rate to be used for calculating valuations, exemplary of an embodiment. In some embodiments, the discount rate and capitalization rate may be pre-defined, and need not be entered by users.

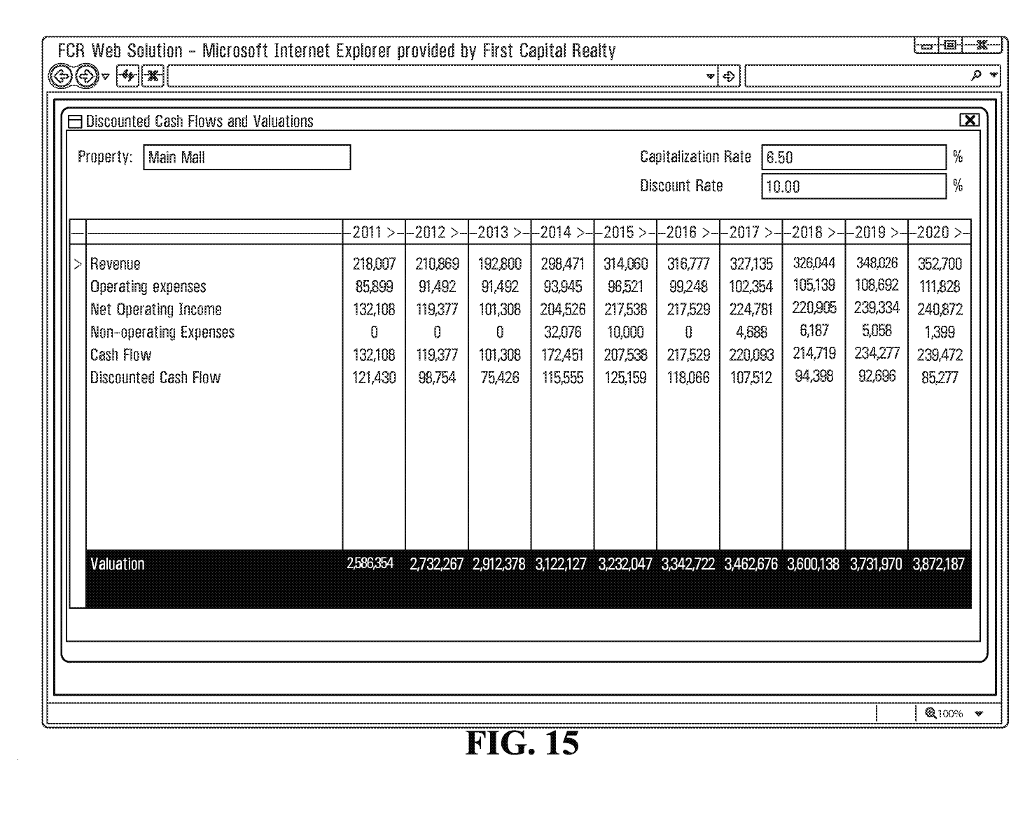

FIG. 15 depicts a sample screen of a user interface presented to users to show calculated valuations. As illustrated, different categories of revenues and expenses, as well as cash flows and discounted cash flows may also be shown to the user by way of this interface.

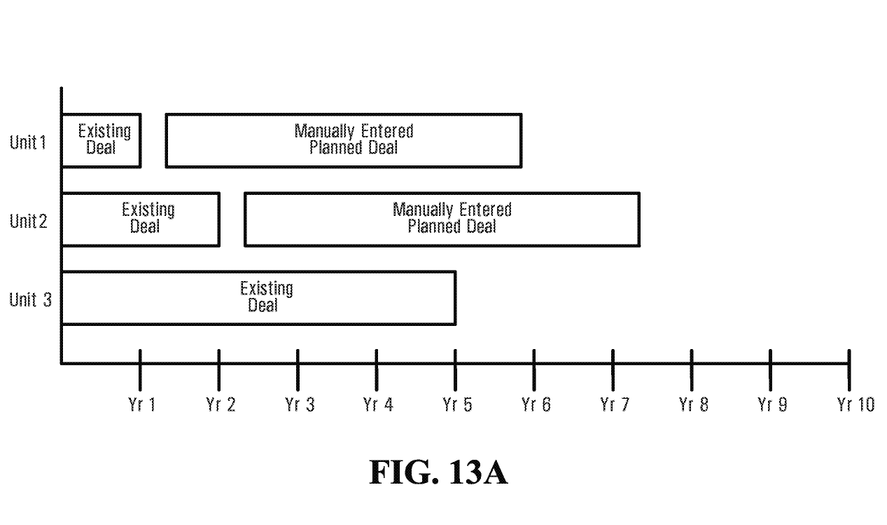

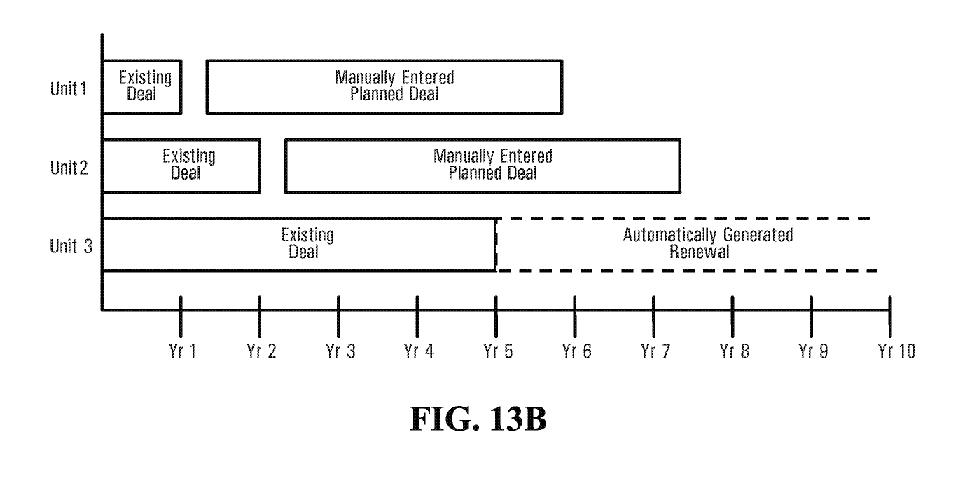

The operation of valuation software 36 is further described with reference to the flowcharts illustrated in FIGS. 11 and 12. To calculate valuations for one or more properties, valuation software 36 performs blocks S1100 at server 12.

At block S1102, users operating computing devices 14 enter terms of existing (executed) leasing agreements and planned (unexecuted) leasing agreements for the leasable units of the property (or properties) to be valued. These terms are entered by way of a user interface presented by deal entry module 42, e.g., as illustrated in FIG. 5. Deal entry module 42 receives these terms and stores them in database 40.

At block S1104, these or other users operating computing devices 14 enter past or current expenses associated with the leasable units. These expenses are entered by way of a user interface presented by expense entry module 44, e.g., as illustrated in FIG. 6. Expense entry module 44 receives these expenses and stores them in database 40.

Next, at block S1106, STF module 46 forecasts revenues and expenses for the short term forecast period for the leasable units of the property (or properties) to be valued. For each leasable units, STF module 46 retrieves the existing leasing agreements and planned leasing agreements for that unit from database 40. Then, for each leasable unit, STF module 46 determines which of the entered planned leasing agreements should be selected for inclusion in the forecasting. For each leasable unit, STF module 46 forecasts revenues in the short term forecast period by analyzing terms of the existing leasing agreement and selected planned leasing agreements which govern rents and recoveries. STF module 46 retrieves current/past expenses for the leasable units from database 40, and forecasts expenses in the short term forecast period by projecting the retrieved expenses over that period.

At block S1108, LTF module 48 forecasts revenues and expenses for the long term forecast period for the leasable units of the property (or properties) to be valued. The operation of LTF module 48 is shown in more detail in blocks S1200 and onward in the flowchart illustrated in FIG. 12.

At block S1202, users of computing devices 14 enter inflations rates for predicted for the long term forecast period. These inflation rates are entered using a user interface presented by LTF module 48, e.g., as illustrated in FIG. 9. Then at block S1204, LTF module 48 retrieves records of the expenses at the end of the short term forecast period, as determined by STF module 46. LTF module 48 projects these retrieved expenses over the long term forecast period, with adjustments for inflation using the rates entered at block S1202.

At block S1206, users of computing devices 14 enter predicted market conditions for renewals in the long term forecast period. These market conditions are entered using a user interface presented by LTF module 48, e.g., as illustrated in FIG. 10.

At block S1208, for each leasable unit, LTF module 48 retrieves terms for existing leasing agreements and planned leasing agreements from database 40. LTF module 48 analyzes these retrieved terms to determine if any vacancy periods for leasable units in the long term forecast period should be filled by generating a predicted renewal of one of these leasing agreements. LTF module 48 automatically generates predicted renewals when an expiring leasing agreement includes a renewal clause. The terms of the predicted renewal are generated from the terms of the expiring lease agreement as well as the predicted market conditions for renewals

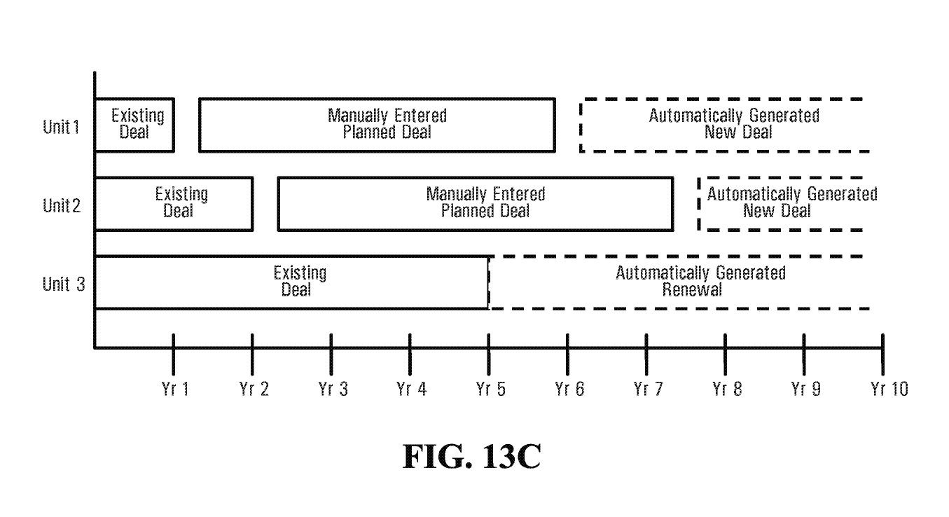

FIG. 13A illustrates an exemplary set of leasing agreements for three separate leasable units (Unit 1-3). As depicted, each of these leasable units has a vacancy period in the long term forecast period. In this depicted example, only the existing leasing agreement for Unit 3 has a renewal clause. Thus, LTF module 48 generates a predicted renewal only for Unit 3. FIG. 13B illustrates the set of leasing agreements for Units 1-3 after LTF module 48 generates this predicted renewal.

After predicted renewals have been generated, operation of LTF module 48 continues at block S1210. At block S1210, users of computing devices 14 enter predicted market conditions for new leasing agreements in the long term forecast period. These market conditions are entered using a user interface presented by LTF module 48, e.g., as illustrated in FIG. 11.

At block S1212, for each leasable unit, LTF module 48 determines if there are any remaining vacancy periods during the long term forecast period. LTF module 48 automatically generates predicted new leasing agreements to fill these remaining vacancies. The terms of these predicted new leasing agreements are generated from the predicted market conditions for new leasing agreements in the long term forecast period.

At block S1214, for each leasable unit, LTF module 48 predicts revenues for the long term forecast period, including revenues from rents (e.g., based on a rate per square foot) and recoveries (e.g., for recovery of expenses such as property taxes, common area management expenses, etc.)

To predict revenues from rents and recoveries for each leasable unit, LTF module 48 analyzes the terms governing such rents for the existing leasing agreement, planned leasing agreements, predicted renewals generated at block S1208 and predicted new leasing agreements generated at block S1212. After revenues have been predicted by LTF module 48, operation of valuation software 36 continues at block S1110.

At block S1110, valuation module 50 calculates future cash flows for the short term forecast period based on revenues/expenses forecasted by STF module 46, as well as future cash flows for the long term forecast period based on revenues/expenses forecasted by LTF module 48.

Also at block S1110, valuation module 50 calculates valuations for the property (or properties) based on the forecasted revenues and expenses. Valuation module 50 presents a user interface to users for entering parameters required to calculate valuations, such as a discount rate and/or a capitalization rate, as shown for example in FIG. 14. Once the necessary parameters have been entered, valuation module 50 calculates annual valuations, for example, using the discounted cash flow valuation technique based on forecasted revenues and expenses. Finally, valuation module 50 presents a user interface to users displaying the calculated valuations, as shown for example in FIG. 15.

Of course, the above described embodiments are intended to be illustrative only and in no way limiting. The described embodiments of carrying out the disclosure are susceptible to many modifications of form, arrangement of parts, details and order of operation. For example, software (or components thereof) described at computing device 12 may be hosted at several devices. Software implemented in the modules described above could be using more or fewer modules. The disclosure, rather, is intended to encompass all such modification within its scope, as defined by the claims.

What is claimed is:

1. A computer-implemented method of valuing a plurality of leasable assets, the method comprising:
creating a data model of future cash flows in defined time periods for the plurality of leasable assets;
populating the data model with rent predicted by analyzing stored records of executed leasing agreements, each executed leasing agreement specifying rent for one of the leasable assets;
populating the data model with rent predicted by analyzing stored records of planned leasing agreements, each planned leasing agreement specifying rent for one of the leasable assets in those of the defined time periods when rent is not specified by one of the executed leasing agreements;
populating the data model with rent predicted for the plurality of leasable assets, by analyzing at least pre-defined market conditions, in those of the defined time periods when rent is not specified by one of the executed leasing agreements or planned leasing agreements; and
calculating a value the plurality of leasable assets in dependence on the populated data model.

2. The method of claim 1, further comprising populating the data model with expenses predicted by analyzing at least stored records of past expenses and the pre-defined market conditions.

3. The method of claim 1, wherein the analyzing stored records of executed leasing agreements comprises determining rent payable according to terms of the executed leasing agreements.

4. The method of claim 1, wherein the analyzing stored records of planned leasing agreements comprises determining rent payable according to terms of the planned leasing agreements.

5. The method of claim 1, wherein at least two of the planned leasing agreements specify rent for one of the leasable assets for a same time period.

6. The method of claim 5, wherein the analyzing stored records of planned leasing agreements comprises selecting a subset of the planned leasing agreements for predicting rent.

7. The method of claim 6, wherein the selecting comprises assessing a likelihood that the planned leasing agreements accurately specifies rents.

8. The method of claim 1, wherein the populating the data model with rent predicted by analyzing at least pre-defined market conditions comprises generating predicted leasing agreements in dependence on the pre-defined market conditions.

9. The method of claim 8, wherein the generating the predicted leasing agreements comprises predicting a renewal of one of the executed leasing agreements.

10. The method of claim 9, wherein the predicting a renewal comprises analyzing the stored record of the executed leasing agreement to identify a renewal clause.

11. The method of claim 1, wherein the calculating comprises calculating a net present value for the future cash flows.

12. The method of claim 11, wherein the calculating takes into account a pre-defined discount rate.

13. The method of claim 1, wherein the calculating comprises calculating a terminal value for plurality of leasable assets.

14. The method of claim 1, wherein the calculating takes into account a pre-defined capitalization rate.

15. The method of claim 1, further comprising receiving the pre-defined market conditions from an operator.

16. The method of claim 1, wherein said pre-defined market conditions comprise predicted inflation rates.

17. The method of claim 16, wherein the inflation rates comprise inflation rates for each of a plurality of pre-defined categories of revenues and expenses.

18. The method of claim 1, wherein the pre-defined market conditions comprise parameters reflecting predicted demand for at least one of the leasable assets.

19. The method of claim 1, wherein the pre-defined market conditions comprise parameters reflecting a predicted rent rate for at least one of the leasable assets.

20. The method of claim 1, further comprising presenting a user interface configured to allow an operator to modify data in the data model.

21. A computing device for valuing a plurality of leasable assets, the computing device comprising:
at least one processor;
memory in communication with the at least one processor; and
software code stored in the memory, which when executed by the at least one processor causes the computing device to:
create a data model of future cash flows in defined time periods for the plurality of leasable assets;
populate the data model with rent predicted by analyzing stored records of executed leasing agreements, each executed leasing agreement specifying rent for one of the leasable assets;
populate the data model with rent predicted by analyzing stored records of planned leasing agreements, each planned leasing agreement specifying rent for one of the leasable assets in those of the defined time periods when rent is not specified by one of the executed leasing agreements;
populate the data model with rent predicted for the plurality of leasable assets, by analyzing at least pre-defined market conditions, in those of the defined time periods when rent is not specified by one of the executed leasing agreements or planned leasing agreements; and
calculate a value the plurality of leasable assets in dependence on the populated data model.

22. A computer-readable medium storing instructions which when executed adapt a computing device to:
create a data model of future cash flows in defined time periods for the plurality of leasable assets;
populate the data model with rent predicted by analyzing stored records of executed leasing agreements, each executed leasing agreement specifying rent for one of the leasable assets;
populate the data model with rent predicted by analyzing stored records of planned leasing agreements, each planned leasing agreement specifying rent for one of the leasable assets in those of the defined time periods when rent is not specified by one of the executed leasing agreements;
populate the data model with rent predicted for the plurality of leasable assets, by analyzing at least pre-defined market conditions, in those of the defined time periods when rent is not specified by one of the executed leasing agreements or planned leasing agreements; and
calculate a value the plurality of leasable assets in dependence on the populated data model.

23. A computer-implemented method of valuing a plurality of leasable assets, the method comprising:
creating a data model of future cash flows in defined time periods for the plurality of leasable assets;
populating the data model with rent predicted by analyzing stored records of leasing agreements, each leasing agreement specifying rent for one of the leasable assets;
populating the data model with rent predicted for the plurality of leasable assets, by analyzing at least pre-defined market conditions, in those of the defined time periods when rent is not specified by one of the leasing agreements; and
calculating a value the plurality of leasable assets in dependence on the populated data model.

24. A computing device for valuing a plurality of leasable assets, the computing device comprising:
at least one processor;
memory in communication with the at least one processor; and
software code stored in the memory, which when executed by the at least one processor causes the computing device to:
create a data model of future cash flows in defined time periods for the plurality of leasable assets;
populate the data model with rent predicted by analyzing stored records of leasing agreements, each leasing agreement specifying rent for one of the leasable assets;
populate the data model with rent predicted for the plurality of leasable assets, by analyzing at least pre-defined market conditions, in those of the defined time periods when rent is not specified by one of the leasing agreements; and
calculate a value the plurality of leasable assets in dependence on the populated data model.

25. A computer-readable medium storing instructions which when executed adapt a computing device to:
create a data model of future cash flows in defined time periods for the plurality of leasable assets;
populate the data model with rent predicted by analyzing stored records of leasing agreements, each leasing agreement specifying rent for one of the leasable assets;
populate the data model with rent predicted for the plurality of leasable assets, by analyzing at least pre-defined market conditions, in those of the defined time periods when rent is not specified by one of the leasing agreements; and
calculate a value the plurality of leasable assets in dependence on the populated data model.

26. A computer-implemented method of predicting rents for a leasable unit of property in a pre-defined prediction period, the method comprising:
storing parameters of a leasing agreement for the leasable unit of property, the parameters specifying rent receivable by a lessor of the leasable unit of property during a portion of the pre-defined prediction period preceding termination of the leasing agreement;
receiving indicators of a plurality of market conditions predicted for the pre-defined prediction period;
generating parameters of at least one predicted leasing agreement, the generated parameters specifying rent predicted to be payable to the lessor during a portion the pre-defined prediction period following termination of the leasing agreement, the generating taking into account the plurality of market conditions; and
predicting rents receivable by the lessor in the pre-defined prediction period by assessing the stored parameters and the generated parameters.

27. A computing device for valuing a plurality of leasable assets, the computing device comprising:
at least one processor;
memory in communication with the at least one processor; and
software code stored in the memory, which when executed by the at least one processor causes the computing device to:
store parameters of a leasing agreement for the leasable unit of property, the parameters specifying rent receivable by a lessor of the leasable unit of property during a portion of the pre-defined prediction period preceding termination of the leasing agreement;
receive indicators of a plurality of market conditions predicted for the pre-defined prediction period;
generate parameters of at least one predicted leasing agreement, the generated parameters specifying rent predicted to be payable to the lessor during a portion the pre-defined prediction period following termination of the leasing agreement, the generating taking into account the plurality of market conditions; and
predict rents receivable by the lessor in the pre-defined prediction period by assessing the stored parameters and the generated parameters.

28. A computer-readable medium storing instructions which when executed adapt a computing device to:
store parameters of a leasing agreement for the leasable unit of property, the parameters specifying rent receivable by a lessor of the leasable unit of property during a portion of the pre-defined prediction period preceding termination of the leasing agreement;
receive indicators of a plurality of market conditions predicted for the pre-defined prediction period;
generate parameters of at least one predicted leasing agreement, the generated parameters specifying rent predicted to be payable to the lessor during a portion the pre-defined prediction period following termination of the leasing agreement, the generating taking into account the plurality of market conditions; and
predict rents receivable by the lessor in the pre-defined prediction period by assessing the stored parameters and the generated parameters.
